(19) United States
(12) Patent Application Publication
(10) Pub. No.: US 2025/0353186 A1
(43) Pub. Date: Nov. 20, 2025

(54) PICKUP ROBOT, PICKUP METHOD, AND COMPUTER-READABLE STORAGE MEDIUM

(71) Applicant: BEIJING GEEKPLUS TECHNOLOGY CO., LTD., Beijing (CN)

(72) Inventors: Yingchun WANG, Beijing (CN); Chao CHEN, Beijing (CN); Xiaoli GUO, Beijing (CN)

(21) Appl. No.: 19/289,255

(22) Filed: Aug. 4, 2025

Related U.S. Application Data
(63) Continuation of application No. 17/634,906, filed on Feb. 11, 2022, now Pat. No. 12,403,608.

(30) Foreign Application Priority Data
Dec. 26, 2019 (CN) 201911368940.5

(51) Int. Cl. B25J 9/16; B65G 1/137; G06K 7/14; G06Q 10/087; G06T 7/11; G06T 7/70; G06V 10/24; G06V 10/75

(52) U.S. Cl. CPC B25J 9/1697; B65G 1/1371; G06K 7/1417; G06T 7/11; G06T 7/70; G06V 10/245; G06V 10/751; G05B 2219/31028; G05B 2219/45063; G06Q 10/087

(57) ABSTRACT

A pickup method includes: obtaining a target image captured when a pickup component moves to each slot where a commodity is stored; when it is determined, on the basis of the slot identifier in the target image, that the current slot is a target slot which stores a commodity to be picked, screening a commodity identifier from the target image; when the commodity identifier is obtained by means of screening, determining, on the basis of the commodity identifier, the position information of the commodity to be picked up in the target slot; and picking up, on the basis of the position information, the commodity from the target slot.

### CROSS-REFERENCE TO RELATED APPLICATIONS

This application is a continuation of U.S. application Ser. No. 17/634,906, filed Feb. 11, 2022, which is a national stage entry under 35 U.S.C. § 371 of International Application No. PCT/CN2020/138291, filed Dec. 22, 2020, which claims priority to Chinese Patent Application No. 201911368940.5, filed Dec. 26, 2019. The entire disclosures of the above-identified application are hereby incorporated herein by reference.

### FIELD

The present disclosure relates to the technical field of computer processing and computer software, and in particular to a pickup robot, a pickup method and a computer readable storage medium.

### BACKGROUND

With the networking of shopping, higher requirements are imposed on the processing speed of logistics industries. A link in the logistics industry is picking up required goods from a warehouse, in which manual pickup is gradually replaced by robot pickup.

In an operation of pickup of a robot, the robot needs to travel to a position where required goods are stored and accurately pick up the goods. In the conventional art, due to the defect in positioning, the failure rate of pickup is high, which reduces the efficiency of pickup and the logistics efficiency of the overall logistics industries.

### SUMMARY

In view of this, a pickup robot, a pickup method, and a computer-readable storage medium are at least provided according to the present disclosure.

In a first aspect, a pickup robot is provided according to the present disclosure provides, which includes: a camera, a processor, and a pickup component. The image capture device is configured to capture a target image when the robot travels to a slot where goods are stored; the processor is configured to filter a slot identifier from the target image, and determine a target slot for goods to be picked up based on the slot identifier; the image capture device is further configured to determine position information of the goods to be picked up in the target image when the goods to be picked up are located in the target slot; and the processor is further configured to control the pick-store component to obtain the goods to be picked up from the target slot based on the position information of the goods to be picked up in the target image.

In a second aspect, a goods process method, applied to a robot, the robot includes an image capture device, a processor, and a pick-store component, and the method includes: capturing, by the image capture device, a target image when the robot travels to a slot where goods are stored; filtering, by the processor, a slot identifier from the target image, and determining a target slot for the goods to be picked up based on the slot identifier; determining, by the image capture device, position information of the goods to be picked up in the target image when the goods to be picked up are located in the target slot; and controlling, by the processor, the pick-store component to obtain the goods to be picked up from the target slot, based on the position information of the goods to be picked up in the target image.

In a third aspect, a computer-readable storage medium storing a computer program is provided according to the present disclosure, where the computer program, when is run by a processor, executes the steps of the above pickup method or storage method.

A pickup robot, a pickup method, and a computer-readable storage medium are provided according to the present disclosure. First, a target image is acquired in a case that the pickup component travels to each slot where goods is stored. Then, goods identifier is searched for from the target image if it is determined that the current slot is a target slot for storing goods to be picked-up based on the slot identifier. In a case that the goods identifier is found, position information of a position of the goods to be picked-up in the target slot is determined based on the goods identifier. Finally, the goods to be picked-up is picked up from the target slot based on the position information. With the above technical solution, the target slot where the goods to be picked-up is stored and the position information of the position of the goods to be picked-up in the target slot can be accurately determined based on the slot identifier and the goods identifier, and the goods to be picked-up can be accurately picked-up based on the determined position information, thereby effectively improving the success rate of pickup, thus facilitating improvement of the logistics efficiency of the logistics industries.

### BRIEF DESCRIPTION OF THE DRAWINGS

In order to explain the technical solutions of the embodiments of the present disclosure more clearly, drawings used in description of the embodiments are briefly described in the following. It should be understood that the drawings only show some embodiments of the present disclosure, and therefore should be regarded as a limitation of the scope. For those skilled in the art, other related drawings may be obtained based on these drawings without creative work.

FIG. 1 shows a schematic structural diagram of a pickup robot according to an embodiment of the present disclosure;

FIG. 2 shows a schematic diagram of a target image in an embodiment of the present disclosure; and

FIG. 3 shows a flowchart of a pickup method according to an embodiment of the present disclosure.

### DETAILED DESCRIPTION OF EMBODIMENTS

In order to make the purpose, technical solutions and advantages of the embodiments of the present disclosure clearer, the technical solutions of the embodiments of the present disclosure will be clearly and completely described in conjunction with the drawings in the embodiments of the present disclosure in the following. It should be understood that the drawings in the present disclosure are used only for the purpose of illustration and description, and are not intended to limit the protection scope of the present disclosure. In addition, it should be understood that the schematic drawings are not drawn to scale. The flowchart used in the present disclosure shows operations implemented according to some embodiments of the present disclosure. It should be understood that the operations of the flowchart may be implemented in another order, and steps without logical context may be implemented in a reverse order or implemented simultaneously. In addition, under the guidance of the content of the present disclosure, those skilled in the art can add one or more other operations to the flowchart, or remove one or more operations from the flowchart.

In addition, the described embodiments are only some of the embodiments of the present disclosure, rather than all the embodiments. The components of the embodiments of the present disclosure generally described and shown in the drawings herein may be arranged and designed in various different configurations. Therefore, the following detailed description of the embodiments of the present disclosure provided in the drawings is not intended to limit the claimed scope of the present disclosure, but merely represents preferred embodiments of the present disclosure. Based on the embodiments of the present disclosure, all other embodiments obtained by those skilled in the art without creative work shall fall within the protection scope of the present disclosure.

It should be noted that the term “including” will be used in the embodiments of the present disclosure to indicate the existence of the features described thereafter, but this does not exclude the addition of other features.

At present, in the logistics industries, in the process of picking up goods from warehouses by using robots, due to the defects in positioning, there is a low success rate of pickup. In view of this, a pickup robot, a pickup method, and a computer readable storage medium are provided according to the present disclosure. In the present disclosure, the target slot where the goods to be picked-up is stored and the position information of the position of the goods to be picked-up in the target slot can be accurately determined based on the slot identifier and the goods identifier, and the goods to be picked-up can be picked up accurately based on the determined position information, thereby effectively improving the success rate of pickup, thus facilitating improvement of the logistics efficiency of the logistics industries.

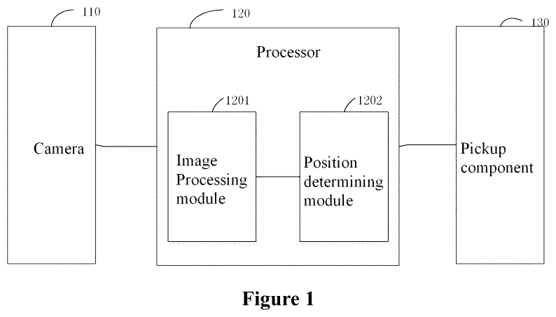

Specifically, a pickup robot is provided according to an embodiment of the present disclosure. As shown in FIG. 1, the pickup robot includes: a camera 110, a processor 120, and a pickup component 130. The processor 120 includes an image processing module 1201 and a position determining module 1202. The camera 110 is configured to acquire a target image in a case that the pickup component 130 travels to each slot where goods is stored. The target image includes a slot identifier corresponding to a current slot. The image processing module 1201 is configured to filter goods identifier from the target image if it is determined, based on the slot identifier, that the current slot is the target slot for storing the goods to be picked-up. The position determining module 1202 is configured to determine position information of a position of the goods to be picked-up in the target slot based on the goods identifier in a case that the goods identifier is found. The pickup component 130 is configured to pick up the goods to be picked-up from the target slot based on the position information.

The camera acquires an image in a preset time interval. The above target image is an image acquired in a case that the pickup robot or the pickup component of the pickup robot travels to the slot where the goods is stored. The image includes a slot identifier corresponding to the slot.

The above slot is used to store goods and the slot identifier may be arranged at a lower part of each slot, such as a lower beam of the slot. The slot identifier is used to identify the corresponding slot, for example, identify an ID number of the slot. In an implementation, the above slot identifier may be set as a two-dimensional code or the like.

After the camera 110 of the pickup robot acquires the target image including the slot identifier, and before the image processing module 1201 searches for the goods identifier from the target image, the pickup robot needs to extract the slot identifier from the target image by using the image processing module 1201, and parse the extracted slot identifier to obtain identification information of the slot. Then, the image processing module 1201 needs to acquire the identification information of the target slot where the goods to be picked-up is stored, and determine whether the identification information of the target slot is the same as the identification information of the slot in the target image. If the identification information of the target slot is the same as the identification information of the slot in the target image, it means that the slot in the target image is the target slot where the goods to be picked-up is stored, if the identification information of the target slot is different from the identification information of the slot in the target image, the slot in the target image is not the target slot where the goods to be picked-up is stored, and the robot needs to travel continually.

In a case that the image processing module 1201 of the pickup robot determines that the slot in the target image is the target slot for storing the goods to be picked-up, the step of searching for the goods identifier from the target image is performed.

The image processing module 1201 extracts the slot identifier from the target image, that is, the image processing module 1201 determines the position information of the position of the slot identifier in the target image. In an implementation, the image processing module 1201 may determine the position information of the slot identifier in the target image in the following steps 1 to 4.

In step 1, binarization processing is performed on the target image, and pixels with a preset gray value are extracted from an image obtained by the binarization processing.

The image processing module 1201 performs binarization processing on the target image to obtain a binarized image.

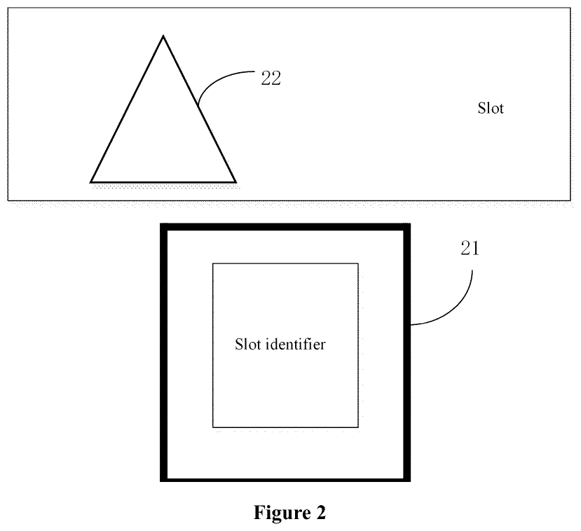

In a case that the binarized image is obtained, the pixels with the preset gray value are extracted from the binarized image, that is, the pixels of a position identifier for positioning the slot identifier are extracted. As shown in FIG. 2, in an implementation, if the position identifier of the slot identifier is represented by a black frame 21 with a certain width, the image processing module 1201 extracts black pixels in this step.

In step 2, based on the extracted pixels, fitting is performed to obtain a candidate position identifier of the slot identifier.

In a case that the image processing module 1201 extracts the pixels of the position identifier, fitting is performed to obtain straight lines so as to obtain a black frame with a certain width. The black frame obtained in this step indicates a candidate position identifier, and further verification is required to determine whether the black frame is the target position identifier used to locate the slot identifier. The intersection of the fitted straight lines is a corner point of the position identifier.

In step 3, if the candidate position identifier meets a preset condition, it is determined that the candidate position identifier is the target position identifier of the slot identifier.

In a case that the candidate position identifier is obtained by fitting, the image processing module 1201 determines, by using a preset condition, whether the candidate position identifier is the target position identifier for positioning a slot identifier. For example, determining whether the line width of the candidate position identifier is equal to a preset width, or determining whether the candidate position identifier has a preset shape, and so on.

If the candidate position identifier meets the preset condition, it is determined that the candidate position identifier is the target position identifier for positioning the slot identifier.

In step 4, the position information of a position of the slot identifier in the target image is determined based on the target position identifier.

In a case that the target position identifier is determined, the image processing module 1201 positions the slot identifier based on a preset relative position relationship between the target position identifier and the slot identifier, that is, determines the position information of the position the slot identifier in the target image.

In a case that the position information of the position of the slot identifier in the target image is determined, the slot identifier may be analyzed to determine whether the current slot in the target image is the target slot where the goods to be picked-up is stored.

If it is determined that the current slot is the target slot for storing the goods to be picked-up, the image processing module 1201 requires to filter the goods identifier from the target image to determine the position information of the position of the goods to be picked-up in the target slot based on the goods identifier.

In an implementation, the image processing module 1201 may filter the goods identifiers from the target image in the following steps 1 to 3.

In step 1, an image area located above the slot identifier in the target image is taken as an interesting area.

In an implementation, the goods identifier is arranged on the goods to be picked-up, and the position of the goods identifier is located higher than the slot identifier. Therefore, in this step, the image area located above the slot identifier is taken as an interesting area to filter the goods identifier. In addition, a size of the slot identifier may be obtained during the calculation process, and the size of the goods identifier may be determined according to the preset information.

In step 2, it is detected whether the interesting area includes an identifier with a preset shape.

In an implementation, as shown in FIG. 2, the goods identifier may be an identifier 22 with a preset shape. Therefore, in this step, it is detected whether the interesting area includes an identifier with a preset shape. The preset shape may be a circle, a triangle, a square or the like, and the shape of the goods identifier is not limited in the present disclosure.

The goods identifier may also be an identifier with a preset color, or may be a two-dimensional code, or the like. The specific form of the goods identifier is not limited in the present disclosure, and the goods identifier is searched for based on the actual specific form of the goods identifier.

In step 3, if the interesting area includes an identifier with a preset shape, the identifier is taken as the goods identifier.

In a case that the interesting area includes an identifier with a preset shape, the image processing module 1201 takes the identifier as the goods identifier.

Since the goods identifier is arranged on the goods, if the image processing module 1201 does not found the goods identifier, it indicates that no goods to be picked-up is stored in the target slot, and the current pickup is failed.

If the image processing module 1201 finds the goods identifier, the position determining module 1202 may determine the position information of the position of the goods to be picked-up in the target slot in the following steps 1 to 2.

In step 1, center position information of a center position of the goods identifier in the target image is determined.

The position determining module 1202 determines the position information of the center position of the goods identifier in the target image by image analysis and other technologies.

In step 2, the position information of the position of the goods to be picked-up in the target slot is determined based on the center position information and relative position information of a relative position between the goods identifier and the goods to be picked-up.

The goods identifier is preset at a preset position on the goods, so that the relative position information of the relative position between the goods identifier and the goods to be picked-up is known. Based on the center position information of the center position of the goods identifier in the target image and the relative position information of the relative position between the goods identifier and the goods to be picked-up, the position information of the position of the goods to be picked-up in the target image can be determined, and then the position information of the position of the goods to be picked-up in the target slot can be determined based on a transformation relationship between the image coordinate system and geographic coordinate system.

In an implementation, the goods identifier may also be arranged at any position of the goods. In this case, the goods identifier may be a two-dimensional code, and the two-dimensional code stores the relative position information of the relative position between the goods identifier and the goods to be picked-up. The position determining module 1202 may obtain the relative position information of the relative position between the goods identifier and the goods to be picked-up by decoding the goods identifier.

In a case that the position determining module 1202 determines the position information of the position of the goods to be picked-up in the target slot, the pickup robot may pick up the goods to be picked-up from the target slot by the pickup component based on the position information.

The pickup component 130 may be a telescopic fork on the pickup robot.

In the above embodiment, the target slot where the goods to be picked-up is stored and the position information of the position of the goods to be picked-up in the target slot can be accurately determined based on the slot identifier and the goods identifier, and the goods to be picked-up can be accurately picked up based on the determined position information, thereby effectively improving the success rate of pickup, thus facilitating improvement of the logistics efficiency of the logistics industries.

Corresponding to the above-described pickup robot, a pickup method is further provided according to an embodiment of the present disclosure, which is applied by the pickup robot and can achieve the same or similar beneficial effects, so the repetitive parts will not be repeated.

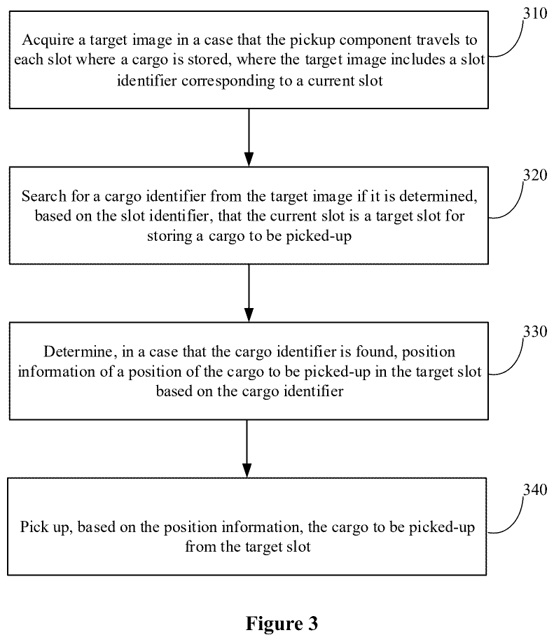

Specifically, as shown in FIG. 3, the pickup method in the present disclosure may include the following steps S310 to S340.

In step S310, a target image is acquired in a case that a pickup component travels to each slot where goods is stored. The target image includes a slot identifier corresponding to a current slot.

In step S320, if it is determined, based on the slot identifier, that the current slot is a target slot for storing goods to be picked-up, goods identifier is searched for from the target image.

In step S330, if the goods identifier is found, position information of a position of the goods to be picked-up in the target slot is determined based on the goods identifier.

In step S340, the goods to be picked-up is picked up from the target slot based on the position information.

In Some Embodiments, after Acquiring the Target Image, the Pickup Method Further Includes:
performing binarization processing on the target image, and extract pixels with a preset gray value from an image obtained by performing the binarization processing;
performing fitting, based on the extracted pixels, to obtain a candidate position identifier of the slot identifier;
determining, if the candidate position identifier meets a preset condition, that the candidate position identifier is a target position identifier of the slot identifier; and
determining, based on the target position identifier, position information of a position of the slot identifier in the target image.

In some embodiments, the slot identifier is a two-dimensional code. The pickup method further includes following steps for determining whether a slot corresponding to the slot identifier is the target slot for storing the goods to be picked-up:
decoding the two-dimensional code based on position information of a position of the two-dimensional code in the target image to obtain identification information of the current slot corresponding to the two-dimensional code; and
determining, if the obtained identification information is the same as identification information of the target slot where the goods to be picked-up is stored, that the current slot corresponding to the two-dimensional code is the target slot.

In some embodiments, the determining the position information of the position of the goods to be picked-up in the target slot based on the goods identifier includes:
determining center position information of a center position of the goods identifier in the target image; and
determining, based on the center position information and relative position information of a relative position between the goods identifier and the goods to be picked-up, where the position information of the position of the goods to be picked-up in the target slot.

In an embodiment, a pickup robot is further provided according to an embodiment of the present disclosure, which includes a camera, a processor, and a pickup component. The processor includes an image processing module and a position determining module.

In the embodiment of the present disclosure, the pickup robot may acquire in advance the position information of the position of the target slot where the goods to be picked-up is stored. In this case, the pickup robot may directly travel to the position where the target slot is stored.

The camera may be configured to acquire a target image in a case that the pickup component travels to a target slot where goods is stored.

The image processing module is configured to filter goods identifier from the target image.

The position determining module is configured to determine, in a case that the goods identifier is found, position information of a position of goods to be picked-up in the target slot based on the goods identifier.

The pickup component is configured to pick up, based on the position information, the goods to be picked-up from the target slot.

The camera takes an image in a preset time interval. The above target image is an image acquired in a case that the pickup robot or the pickup part of the pickup robot travels to the target slot where the goods is stored. The image may include the slot identifier corresponding to the slot.

The slot identifier may be arranged at a lower part of each slot, such as a lower beam of the slot, and the slot identifier is used to identify the corresponding slot, for example, identify the ID number of the slot. In an implementation, the above slot identifier may be set as a two-dimensional code or the like.

After the camera of the pickup robot acquires the target image including the slot identifier, and before the image processing module searches for the goods identifier from the target image, the pickup robot may filter the slot identifier from the target image by the image processing module and analyzes the found slot identifier, to obtain the identification information of the slot. Then, the image processing module may acquire the identification information of the target slot where the goods to be picked-up is stored, and determine whether the identification information of the target slot is the same as the identification information of the slot in the target image. If the identification information of the target slot is the same as the identification information of the slot in the target image, it is determined that the slot in the target image is the target slot where the goods to be picked-up is stored.

The image processing module determines the position information of the position of the slot identifier in the target image. In an implementation, the image processing module may determine the position information of the position of the slot identifier in the target image in the following steps 1 to 4.

In step 1, binarization processing is performed on the target image, and pixels with a preset gray value are extracted from an image obtained by the binarization processing.

The image processing module performs binarization processing on the target image to obtain a binarized image.

In a case that the binarized image is obtained, the pixels with the preset gray value are extracted from the binarized image, that is, the pixels of a position identifier for positioning the slot identifier are extracted. As shown in FIG. 2, in an implementation, if the position identifier of the slot identifier is represented by a black frame 21 with a certain width, the image processing module extracts black pixels in this step.

In step 2, based on the extracted pixels, fitting is performed to obtain a candidate position identifier of the slot identifier.

In a case that the image processing module extracts the pixels of the position identifier, fitting is performed to obtain straight lines so as to obtain a black frame with a certain width. The black frame obtained in this step indicates a candidate position identifier, and further verification is required to determine whether the black frame is the target position identifier used to locate the slot identifier. The intersection of the fitted straight lines is a corner point of the position identifier.

In step 3, if the candidate position identifier meets a preset condition, it is determined that the candidate position identifier is the target position identifier of the slot identifier.

In a case that the candidate position identifier is obtained by fitting, the image processing module determines, by using a preset condition, whether the candidate position identifier is the target position identifier for positioning a slot identifier. For example, determining whether the line width of the candidate position identifier is equal to a preset width, or determining whether the candidate position identifier has a preset shape, and so on.

If the candidate position identifier meets the preset condition, it is determined that the candidate position identifier is the target position identifier for positioning the slot identifier.

In step 4, the position information of a position of the slot identifier in the target image is determined based on the target position identifier.

In a case that the target position identifier is determined, the image processing module positions the slot identifier based on a preset relative position relationship between the target position identifier and the slot identifier, that is, determines the position information of the position the slot identifier in the target image.

In a case that the position information of the position of the slot identifier in the target image is determined, the slot identifier may be analyzed to determine whether the current slot in the target image is the target slot where the goods to be picked-up is stored.

If it is determined that the current slot is the target slot for storing the goods to be picked-up, the image processing module requires to filter the goods identifier from the target image to determine the position information of the position of the goods to be picked-up in the target slot based on the goods identifier.

In an implementation, the image processing module may filter the goods identifiers from the target image in the following steps 1 to 3.

In step 1, an image area located above the slot identifier in the target image is taken as an interesting area.

In an implementation, the goods identifier is arranged on the goods to be picked-up, and the position of the goods identifier is located higher than the slot identifier. Therefore, in this step, the image area located above the slot identifier is taken as an interesting area to filter the goods identifier. In addition, a size of the slot identifier may be obtained during the calculation process, and the size of the goods identifier may be determined according to the preset information.

In step 2, it is detected whether the interesting area includes an identifier with a preset shape.

In an implementation, as shown in FIG. 2, the goods identifier may be an identifier 22 with a preset shape. Therefore, in this step, it is detected whether the interesting area includes an identifier with a preset shape. The preset shape may be a circle, a triangle, a square or the like, and the shape of the goods identifier is not limited in the present disclosure.

The goods identifier may also be an identifier with a preset color, or may be a two-dimensional code, or the like. The specific form of the goods identifier is not limited in the present disclosure, and the goods identifier is searched for based on the actual specific form of the goods identifier.

In step 3, if the interesting area includes an identifier with a preset shape, the identifier is taken as the goods identifier.

In a case that the interesting area includes an identifier with a preset shape, the image processing module takes the identifier as the goods identifier.

Since the goods identifier is arranged on the goods, if the image processing module does not find the goods identifier, it indicates that no goods to be picked-up is stored in the target slot, and the current pickup is failed.

If the image processing module finds the goods identifier, the position determining module may determine the position information of the position of the goods to be picked-up in the target slot in the following steps 1 to 2.

In step 1, center position information of a center position of the goods identifier in the target image is determined.

The position determining module determines the position information of the center position of the goods identifier in the target image by image analysis and other technologies.

In step 2, the position information of the position of the goods to be picked-up in the target slot is determined based on the center position information and the relative position information of a relative position between the goods identifier and the goods to be picked-up.

The goods identifier is preset at a preset position on the goods, so that the relative position information of the relative position between the goods identifier and the goods to be picked-up is known. Based on the center position information of the center position of the goods identifier in the target image and the relative position information of the relative position between the goods identifier and the goods to be picked-up, the position information of the position of the goods to be picked-up in the target image can be determined, and then the position information of the position of the goods to be picked-up in the target slot can be determined based on a transformation relationship between the image coordinate system and geographic coordinate system.

In an implementation, the goods identifier may also be arranged at any position of the goods. In this case, the goods identifier may be a two-dimensional code, and the two-dimensional code stores the relative position information of the relative position between the goods identifier and the goods to be picked-up. The position determining module may obtain the relative position information of the relative position between the goods identifier and the goods to be picked-up by decoding the goods identifier.

In a case that the position determining module determines the position information of the position of the goods to be picked-up in the target slot, the pickup robot may pick up the goods to be picked-up from the target slot by the pickup component based on the position information.

The pickup component may be a telescopic fork on the pickup robot.

In the above embodiment the target slot where the goods to be picked-up is stored and the position information of the position of the goods to be picked-up in the target slot can be accurately determined based on the slot identifier and the goods identifier, and the goods to be picked-up can be accurately picked up based on the determined position information, thereby effectively improving the success rate of pickup, thus facilitating improvement of the logistics efficiency of the logistics industries.

Corresponding to the above pickup robot, a pickup method is further provided according to an embodiment of the present disclosure, which is applied by the pickup robot, and can achieve the same or similar beneficial effects, so the repetitive parts will not be repeated.

Specifically, in an embodiment of the present disclosure, the pickup robot may acquire in advance the position information of the target slot where the goods to be picked-up is stored. In this case, the pickup robot may directly travel to the position where the target slot is stored. The pickup method in present disclosure can include the following steps:

acquiring a target image in a case that a pickup component travels to a target slot where goods is stored;
searching for goods identifier from the target image;
determining, in a case that the goods identifier is found, position information of a position of goods to be picked-up in the target slot based on the goods identifier; and
picking up, based on the position information, the goods to be picked-up from the target slot.

In an embodiment, the target image includes a slot identifier corresponding to a current slot. The searching for goods identifier from the target image includes;

searching for the goods identifier from the target image if it is determined, based on the slot identifier, that the current slot is the target slot for storing the goods to be picked-up.

In some embodiments, after acquiring the target image, the pickup method further includes:
performing binarization processing on the target image, and extract pixels with a preset gray value from an image obtained by performing the binarization processing;
performing fitting, based on the extracted pixels, to obtain a candidate position identifier of the slot identifier;
determining, if the candidate position identifier meets a preset condition, that the candidate position identifier is a target position identifier of the slot identifier; and
determining, based on the target position identifier, position information of a position of the slot identifier in the target image.

In some embodiments, the slot identifier is a two-dimensional code. The pickup method further includes following steps for determining whether a slot corresponding to the slot identifier is the target slot for storing the goods to be picked-up:
decoding the two-dimensional code based on position information of a position of the two-dimensional code in the target image to obtain identification information of the current slot corresponding to the two-dimensional code; and
determining, if the obtained identification information is the same as identification information of the target slot where the goods to be picked-up is stored, that the current slot corresponding to the two-dimensional code is the target slot.

In some embodiments, the determining position information of a position of the goods to be picked-up in the target slot based on the goods identifier includes:
determining center position information of a center position of the goods identifier in the target image; and
determining, based on the center position information and relative position information of a relative position between the goods identifier and the goods to be picked-up, the position information of the position of the goods to be picked-up in the target slot.

A storage robot is further provided according to an embodiment of the present disclosure, which includes: a camera, a processor, and a storage component. The processor includes an image processing module and a position determination module. The camera is configured to acquire a target image in a case that the storage robot travels to a slot where goods is to be stored. The image processing module is configured to filter a slot identifier from the target image. The position determining module is configured to determine, if it is determined that the slot identifier corresponds to the target slot, position information of a position of the goods to be stored in a target slot based on a position of the slot identifier in the target image. The storage component is configured to store the goods to be stored in the target slot based on the position information.

The storage component may be a telescopic fork set on the storage robot.

In the above embodiment, the target slot of the goods to be stored and the position information of the position of the goods to be stored in the target slot can be accurately determined based on the slot identifier and the goods identifier, and the goods to be stored can be accurately stored based on the determined position information, thereby effectively improving the success rate of storage, thus facilitating improvement of the logistics efficiency of the logistics industries.

Those skilled in the art can know that the pickup robot and the storage robot in present disclosure are only used to functionally distinguish the robots from the tasks. In practice, when a robot performs a pickup task, the robot may be regarded as a pickup robot, and when the robot performs a storage task, the robot may be regarded as a storage robot. A pickup part of the pickup robot and a storage part of the storage robot may be realized by the same part that can realize the storage and pickup functions.

Corresponding to the above storage robot, a storage method is further provided according to an embodiment of the present disclosure, which is applied by the above storage robot and can achieve the same or similar beneficial effects, so the repetitive parts will not be repeated.

The storage method according to an embodiment of the present disclosure includes the following steps:
acquiring a target image in a case that a storage robot travels to a target slot where goods is to be stored;
searching for a slot identifier from the target image;
determining position information of a position of the goods to be stored in the target slot based on a position of the slot identifier in the target image; and
storing the goods to be stored in the target slot based on the position information.

A computer program product corresponding to the above method is further provided according to an embodiment of the present disclosure, which includes a computer-readable storage medium storing program codes. Instructions included in the program codes may be used to perform the method in the above method embodiments. For an implementation, reference may be made to the method embodiments, which is not repeated here.

The above description of the various embodiments intends to emphasize the differences between the various embodiments, and the similarities can be referred to each other. For the sake of brevity, details are not repeated herein.

Those skilled in the art can clearly understand that, for convenience and concise of description, the operation process of the system and device described above may refer to the corresponding process in the method embodiment, which will not be repeated in the present disclosure. In the several embodiments of the present disclosure, it should be understood that the disclosed system, device, and method may be implemented in other ways. The device embodiments described above are merely illustrative. For example, the division of the modules is only a logical function division, and there may be other divisions in actual implementations. For example, multiple modules or components may be combined or may be integrated into another system, or some features may be eliminated or not be implemented. In addition, the displayed or discussed mutual coupling or direct coupling or communication connection may be indirect coupling or communication connection through some communication interfaces, devices or modules, and may be in electrical, mechanical or other forms.

The modules described as separate components may or may not be physically separated, and the components displayed as modules may or may not be physical units, that is, they may be located in one place, or they may be distributed on multiple network units. Some or all of the units may be selected according to actual needs to achieve the objectives of the solutions of the embodiments.

In addition, the functional units in the various embodiments of the present disclosure may be integrated into one processing unit, or each unit may exist alone physically, or two or more units may be integrated into one unit.

If the function is implemented in the form of a software functional unit and sold or used as an independent product, it can be stored in a non-volatile computer readable storage medium executable by a processor. Based on this understanding, the technical solution of the present disclosure essentially or the part that contributes to the conventional art or the part of the technical solution may be embodied in the form of a software product, and the computer software product is stored in a storage medium, including several instructions which are used to cause a computer device (which may be a personal computer, a server, or a network device, etc.) to perform all or part of the steps of the methods described in the various embodiments of the present disclosure. The storage medium includes a U disk, a mobile hard disk, an ROM, a RAM, a magnetic disk or an optical disk and other medium that may store program codes.

The above are only preferred embodiments of the present disclosure, but the protection scope of the present disclosure is not limited thereto. Any person skilled in the art may easily think of changes or substitutions within the technical scope disclosed in the present disclosure, which should all fall within the protection scope of the present disclosure. Therefore, the protection scope of the present disclosure shall be subject to the protection scope of the claims.

What is claimed is:

1. A robot, comprising: an image capture device, a processor, and a pick-store component;
the image capture device is configured to capture a target image when the robot travels to a slot where goods are stored;
the processor is configured to filter a slot identifier from the target image, and determine a target slot for goods to be picked up based on the slot identifier;
the image capture device is further configured to determine position information of the goods to be picked up in the target image when the goods to be picked up are located in the target slot; and
the processor is further configured to control the pick-store component to obtain the goods to be picked up from the target slot based on the position information of the goods to be picked up in the target image.

2. The robot according to claim 1, wherein the processor is further configured to:
parse the slot identifier in the target image to obtain identification information of a slot in the target image;
determine whether identification information of the target slot for the goods to be picked up is the same as the identification information of the slot in the target image; and
determine that the slot in the target image is the target slot for the goods to be picked up, in response to the identification information of the target slot for the goods to be picked up is the same as the identification information of the slot in the target image.

3. The robot according to claim 2, wherein the processor is further configured to:
perform binarization processing on the target image, and extract pixels with a preset gray value from an image obtained by performing the binarization processing;
fit, based on the extracted pixels, to obtain a candidate position identifier of the slot identifier;
determine, if the candidate position identifier meets a preset condition, that the candidate position identifier is a target position identifier of the slot identifier; and
determine, based on the target position identifier, position information of a position of the slot identifier in the target image.

4. The robot according to claim 3, wherein the slot identifier is a two-dimensional code, and the processor is further configured to:
decode the two-dimensional code based on position information of a position of the two-dimensional code in the target image to obtain identification information corresponding to the two-dimensional code; and
determine identification information of the slot in the target image based on the identification information corresponding to the two-dimensional code.

5. The robot according to claim 1, wherein the image capture device is further configured to:
obtain preset information corresponding to the goods to be picked up, wherein the preset information is a preset shape or preset color; and
determine whether the goods to be picked up are located in the target slot, based on the preset information corresponding to the goods to be picked up.

6. The robot according to claim 5, wherein the image capture device is further configured to:
determine an image area above the slot identifier in the target image as an interesting area; and
determine the position information of the goods to be picked up in the target image based on the interesting area.

7. The robot according to claim 5, wherein the image capture device is further configured to:
perform binarization processing on the target image, and extract pixels with a preset gray value from an image obtained by performing the binarization processing;
obtain a candidate positioning information of the goods to be picked up, based on the extracted pixel points;
determine the candidate positioning information of the goods to be picked up as target positioning information of the goods to be picked up, in response to the candidate positioning information of the goods to be picked up meets preset conditions; and
determine the position information of the goods to be picked up in the target image based on the target positioning information of the goods to be picked up.

8. The robot according to claim 1, wherein the processor is further configured to:
determine center position information of the goods to be picked up in the target image;
determine the position information of the goods to be picked up in the target slot, based on the center position information; and
control the pick-store component to obtain the goods to be picked up from the target slot, based on the position information of the goods to be picked up in the target slot.

9. The robot according to claim 1, the pick-store component is a telescopic fork mounted on the robot.

10. The robot according to claim 2, wherein the processor is further configured to:
determine that the slot in the target image is not the target slot for the goods to be picked up, in response to the identification information of the target slot for the goods to be picked up differs from the identification information of the slot in the target image, and
control the robot to continue moving.

11. A goods process method, applied to a robot, the robot comprises an image capture device, a processor, and a pick-store component, and the method comprises:
capturing, by the image capture device, a target image when the robot travels to a slot where goods are stored;
filtering, by the processor, a slot identifier from the target image, and determining a target slot for the goods to be picked up based on the slot identifier;
determining, by the image capture device, position information of the goods to be picked up in the target image when the goods to be picked up are located in the target slot; and
controlling, by the processor, the pick-store component to obtain the goods to be picked up from the target slot, based on the position information of the goods to be picked up in the target image.

12. The method according to claim 11, wherein determining the target slot for the goods to be picked up based on the slot identifier comprises:
parsing the slot identifier in the target image to obtain identification information of a slot in the target image;
determining whether identification information of the target slot for the goods to be picked up is the same as the identification information of the slot in the target image; and
determine that the slot in the target image is the target slot for the goods to be picked up, in response to the identification information of the target slot for the goods to be picked up is the same as the identification information of the slot in the target image.

13. The method according to claim 12, wherein parsing the slot identifier in the target image to obtain identification information of the slot in the target image comprises:
performing binarization processing on the target image, and extract pixels with a preset gray value from an image obtained by performing the binarization processing;
fitting, based on the extracted pixels, to obtain a candidate position identifier of the slot identifier;
determining, if the candidate position identifier meets a preset condition, that the candidate position identifier is a target position identifier of the slot identifier; and
determining, based on the target position identifier, position information of a position of the slot identifier in the target image.

14. The method according to claim 13, wherein the slot identifier is a two-dimensional code, and determining, based on the target position identifier, the position information of the position of the slot identifier in the target image, comprises:
decoding the two-dimensional code based on position information of a position of the two-dimensional code in the target image to obtain identification information corresponding to the two-dimensional code; and
determining identification information of the slot in the target image based on the identification information corresponding to the two-dimensional code.

15. The method according to claim 11, wherein the method further comprises:
obtaining, by the image capture device, preset information corresponding to the goods to be picked up, wherein the preset information is a preset shape or preset color; and
determining, by the image capture device, whether the goods to be picked up are located in the target slot, based on the preset information corresponding to the goods to be picked up.

16. The method according to claim 15, wherein determining the position information of the goods to be picked up in the target image comprises:
determining an image area above the slot identifier in the target image as an interesting area; and
determining the position information of the goods to be picked up in the target image based on the interesting area.

17. The method according to claim 15, wherein determining the position information of the goods to be picked up in the target image comprises:
performing binarization processing on the target image, and extract pixels with a preset gray value from an image obtained by performing the binarization processing;
obtaining a candidate positioning information of the goods to be picked up, based on the extracted pixel points;
determining the candidate positioning information of the goods to be picked up as target positioning information of the goods to be picked up, in response to the candidate positioning information of the goods to be picked up meets preset conditions; and
determining the position information of the goods to be picked up in the target image based on the target positioning information of the goods to be picked up.

18. The method according to claim 11, wherein controlling the pick-store component to obtain the goods to be picked up from the target slot, based on the position information of the goods to be picked up in the target image comprises:
determining a center position information of the goods to be picked up in the target image;
determining the position information of the goods to be picked up in the target slot, based on the center position information; and
controlling the pick-store component to obtain the goods to be picked up from the target slot, based on the position information of the goods to be picked up in the target slot.

19. The method according to claim 12, wherein the method further comprises:
determining that the slot in the target image is not the target slot for the goods to be picked up, in response to the identification information of the target slot for the goods to be picked up differs from the identification information of the slot in the target image, and
controlling the robot to continue moving.

20. A non-transitory computer-readable storage medium storing a computer program, wherein the computer program, when is run by a processor, executes a goods process method, applied to a robot, the robot comprises an image capture device, the processor, and a pick-store component, and the method comprises:
capturing, by the image capture device, a target image when the robot travels to slot where goods are stored;
filtering, by the processor, a slot identifier from the target image, and determining a target slot for the goods to be picked up based on the slot identifier;
determining, by the image capture device, position information of the goods to be picked up in the target image when the goods to be picked up are located in the target slot; and
controlling, by the processor, the pick-store component to obtain the goods to be picked up from the target slot, based on the position information of the goods to be picked up in the target image.
